(19) United States
(12) Patent Application Publication
(10) Pub. No.: US 2008/0064756 A1
(43) Pub. Date: Mar. 13, 2008

(54) Use of Alcohol-Oxyalkylates in the Form of Adjuvants for Benzamidoxime Fungicidal Derivatives, Appropriate Agents and Kits

(75) Inventors: Rainer Berghaus, Speyer (DE); Maria Scherer, Landau (DE); Reinhard Stierl, Freinsheim (DE); Siegfried Strathmann, Limburgerhof (DE)

Correspondence Address: BIRCH STEWART KOLASCH & BIRCH, PO BOX 747, FALLS CHURCH, VA, 22040-0747, US

(73) Assignee: BASF Aktiengesellschaft, Ludwigshafen (DE)

(21) Appl. No.: 10/566,297

(22) PCT Filed: Aug. 13, 2004
(86) PCT No.: PCT/EP04/09122

§ 371 Date: Jan. 11, 2007

(30) Foreign Application Priority Data
Aug. 14, 2003 (DE) 103 37 560.0

(51) Int. Cl. A01N 37/52

(52) U.S. Cl. 514/617

(57) ABSTRACT

The present invention relates to the use of alkoxylated alcohols (alcohol alkoxylates) as adjuvant for improving the fungicidal action of benzamide oxime derivatives of the formula (I)

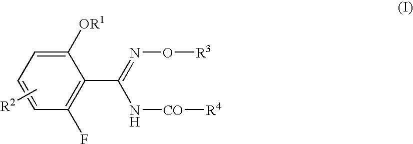

such as, for example,
N-phenylacetyl-2-difluoromethoxy-5,6-difluorobenzamide (O-cyclopropylmethyl)oxime or
N-phenylacetyl-2-trifluoromethoxy-5,6-difluorobenzamide (O-cyclopropylmethyl)oxime.

The present invention also relates to corresponding compositions and kits.

The present invention relates to the use of alcohol alkoxylates as adjuvant for fungicidal benzamide oxime derivatives, to corresponding compositions comprising at least one fungicidal benzamide oxime derivative and at least one alcohol alkoxylate, and to kits comprising the benzamide oxime derivative and alcohol alkoxylate in separate containers.

In addition to the optimization of the active compound properties, the development of an effective composition is of particular importance with a view to industrial production and application of these active compounds. An optimum balance between properties, such as the biological activity, the toxicology, possible effects on the environment and the costs, which are to some extent conflicting, has to be found through proper formulating of the active compound or compounds. In addition, the formulating determines to a considerable extent the stability and the ease of application of the composition. This is also valid for the fungicidal benzamide oxime derivatives known from EP-A-1017670 (WO 99/14187), EP-A 805 148 (WO 96/19442) and EP-A 1 077 028 (WO 99/56549).

The addition to formulations of certain auxiliaries in order to improve the activity is generally known and agricultural practice. The active compound amounts in the formulation can thereby advantageously be reduced while maintaining the activity, which minimizes costs, and, if appropriate, current statutory regulations can be adhered to. In individual cases, success is also achieved in expanding the spectrum of action, as plants which, without additive, can only be treated inadequately with a certain active compound can be appropriately treated by addition of certain auxiliaries. In addition, the performance under unsuitable environmental conditions can in individual cases be enhanced by a suitable formulation. Consequently, incompatibilities between various active compounds in a formulation can also be avoided.

Such auxiliaries are occasionally also described as adjuvants. They are often surface-active or saline compounds. Depending on the mode of action, modifiers, actuators, fertilizers and pH buffers, for example, can be distinguished. Modifiers influence the wetting, adhesion and spreading of a formulation. Actuators break open the waxy cuticle of plants and improve the penetration of the active compound into the cuticle, both in the short term (within minutes) and in the long term (within hours). Fertilizers such as ammonium sulfate, ammonium nitrate or urea improve the absorption and solubility of the active compound and they may reduce antagonistic ways of behavior of active compounds. pH buffers are conventionally used for optimum adjustment of the pH of the formulation.

With regard to the uptake of the active compound in the leaf, surface-active substances may act as modifiers and actuators. It is generally assumed that suitable surface-active substances can increase the effective contact area of liquids on leaves by reducing the surface tension. In addition, certain surface-active substances can dissolve or break open the epicuticular waxes, which facilitates the absorption of the active compound. Furthermore, some surface-active substances can also improve the solubility of active compounds in formulations and therefore prevent, or at least delay, crystallization. Finally, they can in certain cases also influence the absorption of active compounds by retaining moisture.

Adjuvants of surface-active type are used in a variety of ways for agrotechnical applications. They can be subdivided into anionic, cationic, nonionic or amphoteric groups of substances.

Petroleum-based oils are conventionally used as activating adjuvants. More recently, seed extracts, natural oils and their derivatives, for example from soya bean, sunflower and coconut, have also been used.

Synthetic surface-active substances, which are generally used as actuators, are inter alia polyoxyethylene condensates with alcohols, alkylphenols or alkylamines which exhibit HLB values in the range from 8 to 13. In this spirit, WO 00/42847 mentions, for example, the use of certain linear alcohol alkoxylates in order to increase the activity of agrotechnical biocidal formulations. WO 02/15697 likewise discloses the use of alcohol alkoxylates as adjuvants in the formulation of triazolopyrimidines.

It was an object to improve the activity of the said benzamide oxime derivatives during their application.

It has been found that alkoxylated alcohols exhibit a particularly good adjuvant effect during the application of the benzamide oxime derivatives.

The present invention therefore relates to the use of alkoxylated alcohols (alcohol alkoxylates) as adjuvant for improving the fungicidal effect of benzamide oxime derivatives of the formula (I)

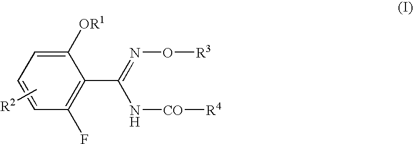

in which the substituents have the following meanings:
R¹ is difluoromethyl or trifluoromethyl;
R² is hydrogen or fluorine;
R³ is C₁-C₄-alkyl, which can be substituted by cyano, C₁-C₄-haloalkyl, C₁-C₄-alkoxy-C₁-C₄-alkyl, C₃—C₆-alkenyl, C₃—C₆-haloalkenyl, C₃—C₆-alkynyl or C₃—C₈-cycloalkyl-C₁-C₄-alkyl;
R⁴ is phenyl-C₁-C₆-alkyl, which can carry, on the phenyl ring, one or more substituents chosen from halogen, C₁-C₄-alkyl, C₁-C₄-haloalkyl, C₁-C₄-alkoxy and C₁-C₄-haloalkoxy, or thienyl-C₁-C₄-alkyl, which can carry, on the thienyl ring, one or more substituents chosen from halogen, C₁-C₄-alkyl, C₁-C₄-haloalkyl, C₁-C₄-alkoxy and C₁-C₄-haloalkoxy, or pyrazolyl-C₁-C₄-alkyl, which can carry, on the pyrazolyl ring, one or more substituents chosen from halogen, C₁-C₄-alkyl, C₁-C₄-haloalkyl, C₁-C₄-alkoxy or C₁-C₄-haloalkoxy.

At least some of the alcohol alkoxylates to be used are known per se. For example, WO 01/77276 and U.S. Pat. No. 6,057,284 or EP 0 906 150 describe suitable alcohol alkoxylates. Reference is herewith expressly made to the description of these alcohol alkoxylates in these publications, whereby the alcohol alkoxylates themselves disclosed therein and also their preparation are part of the present disclosure.

The alcohol portion of the alcohol alkoxylates to be used according to the invention is generally based on alcohols or alcohol mixtures known per se with 5 to 30, preferably 8 to 20 and in particular 9 to 15 carbon atoms. Mention may in particular be made, in this connection, of fatty alcohols with approximately 8 to 20 carbon atoms. As is known, many of these fatty alcohols are used to prepare nonionic and anionic surfactants, to which end the alcohols are subjected to an appropriate functionalization, e.g. by alkoxylation or glycosidation.

The alcohol portion of the alkoxylates to be used can be straight-chain, branched or cyclic. When it is linear, mention may in particular be made of alcohols with 14 to 20, for example with 16-18, carbon atoms. When it is-branched, the main chain of the alcohol portion, according to a particular embodiment, generally exhibits 1 to 4 branchings, it also being possible to use alcohols with a higher or lower degree of branching in the mixture with additional alcohol alkoxylates, provided that the mean number of the branchings in the mixture is in the abovementioned range.

The alcohol portion of the alkoxylates to be used can be saturated or unsaturated. When it is unsaturated, it exhibits, according to one particular embodiment, one double bond.

The branchings generally exhibit, independently of one another, 1 to 10, preferably 1 to 6 and in particular 1 to 4 carbon atoms. Particular branchings are methyl, ethyl, n-propyl or isopropyl groups.

Suitable alcohols and in particular fatty alcohols can be obtained both from natural sources, e.g. by extraction and, if necessary or if desired, by hydrolysis, transesterification and/or hydrogenation of glycerides and fatty acids, and synthetically, e.g. by synthesizing from starting materials with a smaller number of carbon atoms. Thus, for example, olefin fractions with a carbon number suitable for further processing to surfactants are obtained, starting from ethene, according to the SHOP (Shell Higher Olefin Process) process. The functionalization of the olefins to the corresponding alcohols is carried out, e.g., by hydroformylation and hydrogenation.

Olefins with a carbon number suitable for further processing to suitable alcohols can also be obtained by oligomerization of C₃-C₆-alkenes, such as, in particular, propene or butene or mixtures thereof.

In addition, lower olefins can be oligomerized by means of heterogeneous acid catalysts, e.g. supported phosphoric acid, and can be subsequently functionalized to alcohols.

A general possible synthetic route for the preparation of branched alcohols is,. e.g., the reaction of aldehydes or ketones with Grignard reagents (Grignard synthesis). Aryl- or alkyllithium compounds, which are distinguished by a higher reactivity, can be used in place of Grignard reagents. In addition, the branched alcohols can be obtained by aldol condensation, the reaction conditions being known to a person skilled in the art.

The alkoxylation results from the reaction with suitable alkylene oxides generally exhibiting 2 to 15 and preferably exhibiting 2 to 6 carbon atoms. Mention may in particular be made, in this respect, of ethylene oxide (EO), propylene oxide (PO), butylene oxide (BO), pentylene oxide (PeO) and hexylene oxide (HO).

One type of alcohol alkoxylates to be used is based on one kind of alkylene oxide.

A further type of alcohol alkoxylates to be used is based on at least two different kinds of alkylene oxide. In this context, it is preferred to arrange several alkylene oxide units of one kind as a block, so that at least two different alkylene oxide blocks are produced which are each formed from several units of the same alkylene oxides. When such block alkoxylates are used, it is preferred that the alkylene oxide portion be composed of 3 and in particular of 2 blocks.

According to one aspect, it is preferred that the alcohol alkoxylates to be used according to the invention be ethoxylated or exhibit at least one ethylene oxide block. According to an additional aspect, ethylene oxide blocks are combined, in particular with propylene oxide or pentylene oxide blocks.

The respective degree of alkoxylation obtained depends on the amounts of alkylene oxide(s) chosen to be used for the reaction and on the reaction conditions. It is generally, in this connection, a statistical mean value, since the number of alkylene oxide units of the alcohol alkoxylates resulting from the reaction varies.

The degree of alkoxylation, i.e. the mean chain length of the polyether chains of the alcohol alkoxylates to be used according to the invention, can be determined by the molar ratio of alcohol to alkylene oxide. Preference is given to alcohol alkoxylates with approximately 1 to 100, preferably approximately 2 to 15, in particular 3 to 12, especially 4 to 12 and in particular 5 to 12 alkylene oxide units.

The reaction of the alcohols or alcohol mixtures with the alkylene oxide(s) is carried out according to conventional processes known to a person skilled in the art and in conventional apparatuses therefor.

The alkoxylation can be catalyzed by strong bases, such as alkali metal hydroxides and alkaline earth metal hydroxides, Brönsted acids or Lewis acids, such as AlCl₃, BF₃, and the like. Catalysts such as hydrotalcite or DMC can be used for alcohol alkoxylates with a narrow distribution.

The alkoxylation is preferably carried out at temperatures ranging from approximately 80 to 250° C., preferably approximately 100 to 220° C. The pressure is preferably between ambient pressure and 600 bar. If desired, the alkylene oxide can comprise an admixture of inert gas, e.g. from approximately 5 to 60%.

Accordingly, the alkoxylated alcohols to be used are chosen in particular from alcohol alkoxylates of the formula (II)

R⁶—O—(CₘH₂ₘO)ₓ—(CₙH₂ₙO)_{y}—(CₚH₂ₚO)_{z}—H (II)

in which
R⁶ represents C₅-C₃₀-alkyl or C₅-C₃₀-alkenyl;
m,n,p represent, independently of one another, an integer from 2 to 16, preferably 2, 3, 4 or 5;
x,y,z represent, independently of one another, a number from 0 to 100; and
x+y+z corresponds to a value from 1 to 100,

and the forms of these alcohol alkoxylates of the formula (II) resulting from consideration of the above embodiments.

According to a particular embodiment, alcohol alkoxylates of the formula (II) are used in which m=2 and the value of x is greater than zero. This relates on this occasion to alcohol alkoxylates of EO type to which belong especially alcohol ethoxylates (m=2; x>zero; y, z=zero) and alcohol alkoxylates with an EO block bonded to the alcohol portion (m=2; x>zero; y and/or z>zero). Mention may be made, from the alcohol alkoxylates with an EO block bonded to the alcohol portion, especially of EO-PO block alkoxylates (m=2; x>zero; y>zero; n=3; z=0), EO-PeO block alkoxylates (m=2; x>zero; y>zero; n=5; z=0) and EO-PO-EO block alkoxylates (m, p=2; x, z>zero; y>zero; n=3).

Preference is given to EO-PO block alkoxylates in which the ratio of EO to PO (x to y) is 1:1 to 4:1 and in particular 1.5:1 to 3:1. In this context, the degree of ethoxylation (value of x) is generally 1 to 20, preferably 2 to 15 and in particular 4 to 10 and the degree of propoxylation (value of y) is generally 1 to 20, preferably 1 to 8 and in particular 2 to 5. The overall degree of alkoxylation, i.e. the sum of EO and PO units, is generally 2 to 40, preferably 3 to 25 and in particular 6 to 15.

Preference is furthermore given to EO-PeO block alkoxylates in which the ratio of EO to PeO (x to y) is 2:1 to 25:1 and in particular 4:1 to 15:1. In this context, the degree of ethoxylation (value of x) is generally 1 to 50, preferably 4 to 25 and in particular 6 to 15 and the degree of pentoxylation (value of y) is generally 0.5 to 20, preferably 0.5 to 4 and in particular 0.5 to 2. The overall degree of alkoxylation, i.e. the sum of EO and PeO units, is generally 1.5 to 70, preferably 4.5 to 29 and in particular 6.5 to 17.

According to a further particular embodiment, alcohol alkoxylates of the formula (II) are used in which n=2, the values of x and y are both greater than zero and z=0. On this occasion also, these are alcohol alkoxylates of EO type but in which the EO block is terminally bonded. These include especially PO-EO block alkoxylates (n=2; x>zero; y>zero; m=3; z=0) and PeO-EO block alkoxylates (n=2; x>zero; y>zero; m=5; z=0).

Preference is given to PO-EO block alkoxylates in which the ratio of PO to EO (x to y) is 1:10 to 3:1 and in particular 1.5:1 to 1:6. In this context, the degree of ethoxylation (value of y) is generally 1 to 20, preferably 2 to 15 and in particular 4 to 10 and the degree of propoxylation (value of x) is generally 0.5 to 10, preferably 0.5 to 6 and in particular 1 to 4. The overall degree of alkoxylation, i.e. the sum of EO and PO units, is generally 1.5 to 30, preferably 2.5 to 21 and in particular 5 to 14.

Preference is furthermore given to PeO-EO block alkoxylates in which the ratio of PeO to EO (x to y) is 1:50 to 1:3 and in particular 1:25 to 1:5. In this context, the degree of pentoxylation (value of x) is generally 0.5 to 20, preferably 0.5 to 4 and in particular 0.5 to 2 and the degree of ethoxylation (value of y) is generally 3 to 50, preferably 4 to 25 and in particular 5 to 15. The overall degree of alkoxylation, i.e. the sum of EO and PeO units, is generally 3.5 to 70, preferably 4.5 to 45 and in particular 5.5 to 17.

According to a further particular embodiment, alcohol alkoxylates of the formula (II) are used in which the values of x, y and z are all greater than zero. These include especially PeO-EO-PO block alkoxylates (m=5; x>zero; n=2; y>zero; m=3; z>zero).

According to a preferred embodiment, the alcohol alkoxylates to be used according to the invention are based on primary α-branched alcohols of the formula (III),

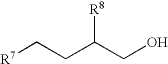

in which
R⁷, R⁸ represent, independently of one another, hydrogen or C₁-C₂₆-alkyl.

Preferably, R⁷ and R⁸ represent, independently of one another, C₁-C₆-alkyl and in particular C₂-C₄-alkyl.

Alcohol alkoxylates based on 2-propylheptanol ae very particularly preferred. These include in particular alcohol alkoxylates of the formula (II) in which R represents a 2-propylheptyl residue, i.e. R⁷ and R⁸ in formula (III) denote in each case n-propyl.

Such alcohols are also described as Guerbet alcohols. These can be obtained, for example, by dimerization of the corresponding primary alcohols (e.g., R^{7,8}—CH₂CH₂OH) at elevated temperature, for example 180 to 300° C., in the presence of an alkaline condensing agent, such as potassium hydroxide.

Alkoxylates of EO type are applied especially within the scope of this preferred embodiment based on Guebert alcohols. Particular preference is given to ethoxylates with a degree of ethoxylation of 1 to 50, preferably 2 to 20 and in particular approximately 3 to 10. Mention may especially be made, among these, of the appropriately ethoxylated 2-propylheptanols.

According to a further preferred embodiment, the alcohol alkoxylates to be used are based on C₁₃ oxo alcohols.

The term “C₁₃ oxo alcohol” generally describes an alcohol mixture, the main component of which is formed of at least one branched C₁₃ alcohol (isotridecanol). Such C₁₃ alcohols include in particular tetramethylnonanols, for example 2,4,6,8-tetramethyl-1-nonanol or 3,4,6,8-tetramethyl-1-nonanol, and also ethyldimethylnonanols, such as 5-ethyl-4,7-dimethyl-1-nonanol.

Suitable C₁₃ alcohol mixtures can generally be obtained by hydrogenation of hydroformylated trimeric butene. In particular, it is possible
a) to bring butenes into contact with a suitable catalyst for the purpose of oligomerizing,
b) to isolate a C₁₂ olefin fraction from the reaction mixture,
c) to hydroformylate the C₁₂ olefin fraction by reaction with carbon monoxide and hydrogen in the presence of a suitable catalyst, and
d) to hydrogenate.

Advantageous C₁₃ alcohol mixtures are essentially free from halogens, i.e. they comprise less than 3 ppm by weight, in particular less than 1 ppm by weight, of halogen, in particular chlorine.

The butene trimerization can be carried out by means of homogeneous or heterogeneous catalysis.

In the DIMERSOL process (cf. Revue de l'Institut Francais du Petrole, Vol. 37, No. 5, September/October 1982, p. 639ff), butenes are oligomerized in the homogeneous phase in the presence of a catalyst system formed from a transition metal derivative and an organometallic compound. Typical catalyst systems are Ni(O) complexes in combination with Lewis acids, such as AlCl₃, BF₃, SbF₅, and so on, or Ni(II) complexes in combination with alkylaluminum halides.

Alternatively, butenes can be oligomerized in a way known per se on a nickel-comprising heterogeneous catalyst (processing stage a). Different relative amounts of butene dimers, trimers and higher oligomers are obtained, depending on the processing conditions chosen. For the present purposes, the butene trimers, i.e. C₁₂ olefins, are further processed. The content of isobutenes can be chosen with regard to the desired degree of branching of the C₁₃ alcohol mixture obtained after hydroformylation/hydrogenation. Relatively low degrees of branching require a relatively low isobutene content and vice versa. If the C₁₂ olefin fraction is supposed to have, for example, an ISO number of approximately 1.9 to 2.3, it is advisable for the butenes used to be chosen to be predominantly linear, i.e. the hydrocarbon stream generally used should comprise less than 5% by weight, based on the butene fraction, of isobutene. The butenes can comprise an admixture of saturated C₄ hydrocarbons which act as diluent in the oligomerization.

The heterogeneous nickel-comprising catalysts which can be used can exhibit different structures, catalysts comprising nickel oxide being preferred. Catalysts known per se, as they are described in C. T. O'Connor et al., Catalysis Today, Vol. 6 (1990), p. 336-338, are suitable.

The hydrocarbon stream (preferably C₄ stream) generally comprises 50 to 100% by weight, preferably 60 to 90% by weight, of butenes and 0 to 50% by weight, preferably 10 to 40% by weight, of butanes. The butene fraction comprises less than 5% by weight, in particular less than 3% by weight, of isobutene, based on the butene fraction. The butene fraction generally exhibits the following composition (in each case based on the butene fraction):

| | | |
|---|---|---|
| 1-butene | 1 to 50% | by weight |
| cis-2-butene | 1 to 50% | by weight |
| trans-2-butene | 1 to 99% | by weight |
| isobutene | 1 to 5% | by weight |

“Raffinate II”, which is a C₄ fraction depleted in isobutenes from an FCC plant or a steam cracker, is used as particularly preferred feedstock.

A C₁₂ olefin fraction is isolated in one or more separation stages from the reaction product of the oligomerization reaction (processing stage b). Suitable separating apparatuses are the conventional apparatuses known to a person skilled in the art. These include, e.g., distillation columns, such as plate columns, which can be equipped, if desired, with bubble caps, sieve plates, sieve trays, valves, side offtakes, and so on, evaporators, such as thin-film evaporators, falling-film evaporators, wiped-film evaporators, Sambay evaporators, and so on, and combinations thereof. The isolation of the C₁₂ olefin fraction is preferably carried out by fractional distillation.

The ISO number of the C₁₂ olefin fraction, which indicates the mean number of the branchings, is generally 1 to 4, preferably 1.9 to 2.3, in particular 2.0 to 2.3. The ISO number can, e.g., be determined by hydrogenating a sample of the C₁₂ olefin fraction to the dodecanes and ascertaining in the ¹H NMR spectrum, from the signal area which can be assigned to the methyl groups and the signal area which can be assigned to the total protons, the mean number of the methyl groups. The ISO number is the mean of the methyl groups minus two.

To prepare an alcohol mixture according to the invention, the isolated C₁₂-olefin fraction is hydroformylated to C₁₃-aldehydes (processing stage c) and subsequently hydrogenated to C₁₃-alcohols (processing stage d). In this context, the preparation of the alcohol mixture can be carried out in a single stage or in two separate reaction stages.

A review of hydroformylation processes and suitable catalysts is to be found in Beller et al., Journal of Molecular Catalysis, A104 (1995), p. 17-85.

The hydroformylation is preferably carried out in the presence of a cobalt hydroformylation catalyst. The amount of the hydroformylation catalyst is generally 0.001 to 0.5% by weight, calculated as cobalt metal, based on the amount of the olefins to be hydroformylated. The reaction temperature generally ranges from approximately 100 to 250° C., preferably 150 to 210° C. The reaction can be carried out at an elevated pressure of approximately 10 to 650 bar. It is preferred that the hydroformylation be carried out in the presence of water, but it can also be carried out in the absence of water.

Carbon monoxide and hydrogen are generally used in the form of a mixture known as synthesis gas. The composition of the synthesis gas used can vary within a wide range. The molar ratio of carbon monoxide to hydrogen is generally approximately 2.5:1 to 1:2.5. A preferred ratio is approximately 1:1.5.

The cobalt catalyst, which is homogeneously dissolved in the reaction medium, can be suitably separated from the hydroformylation product by treating the reaction product of the hydroformylation with oxygen or air in the presence of an acidic aqueous solution. In the course of this, the cobalt catalyst is oxidatively destroyed with the formation of cobalt(II) salts. The cobalt(II) salts are water soluble and are extracted into the aqueous phase, which can be separated and recycled to the hydroformylation process.

If desired, the crude aldehydes or aldehyde/alcohol mixtures obtained in the hydroformylation can, before the hydrogenation, be isolated and, if appropriate, purified according to conventional processes known to a person skilled in the art.

For the hydrogenation, the reaction mixtures obtained in the hydroformylation are reacted with hydrogen in the presence of a hydrogenation catalyst.

Suitable hydrogenation catalysts are generally transition metals, such as, e.g., Cr, Mo, W, Fe, Rh, Co, Ni, Pd, Pt, Ru, and so on, or their mixtures, which can be applied to supports, such as, e.g., active charcoal, aluminum oxide, kieselguhr, and so on, in order to increase the activity and stability. Fe, Co and preferably Ni, also in the form of the Raney catalysts as metal sponge with a very large surface area, can be used to increase the catalytic activity. A Co/Mo catalyst is preferably used for the preparation of the surface-active alcohols according to the invention. The hydrogenation of the oxo aldehydes is carried out, depending on the activity of the catalyst, preferably at elevated temperatures and elevated pressure. The hydrogenation temperature is preferably at approximately 80 to 250° C. and the pressure is preferably at approximately 50 to 350 bar.

Further suitable C₁₃ alcohol mixtures can be obtained by
a) subjecting a C₄ olefin mixture to metathesis,
b) separating olefins with 6 carbon atoms from the metathesis mixture,
c) subjecting the separated olefins, individually or as a mixture, to dimerization to olefin mixtures with 12 carbon atoms, and
d) subjecting the olefin mixture obtained, if appropriate after fractionation, to derivatization to a mixture of C13 oxo alcohols.

The essential features of the metathesis used in processing stage a) have been described, for example, in Ullmann's Encyclopedia of Industrial Chemistry, 5^{th} edition, Volume A18, p.235/236. Further information on carrying out the process can be taken from, for example, K. J. Ivin, Olefin Metathesis, Academic Press, London, (1983); Houben-Weyl, E18, 1163-1223; R. L. Banks, Discovery and Development of Olefin Disproportionation, CHEMTECH (1986), February, 112-117.

When metathesis is applied to the main components 1-butene and 2-butene present in the C₄ olefin streams, olefins with 5 to 10 carbon atoms, preferably with 5 to 8 carbon atoms, in particular however 2-pentene and 2-hexene, are formed in the presence of suitable catalysts.

Suitable catalysts are preferably molybdenum, tungsten or rhenium compounds. It is particularly advisable to carry out the reaction under heterogeneous catalysis conditions, the catalytically active metals being used in particular in combination with supports made of Al₂O₃ or SiO₂. Examples of such catalysts are MoO₃ or WO₃ on SiO₂, or Re₂O₇ on Al₂O₃.

It is particularly convenient to carry out the metathesis in the presence of a rhenium catalyst since, in this case, particularly mild reaction conditions are possible. Thus, in this case, the metathesis can be carried out at a temperature of 0 to 50° C. and at lower pressures of approximately 0.1 to 0.2 MPa.

In the dimerization of the olefins or olefin mixtures obtained in the metathesis stage, dimerization products are obtained which exhibit particularly suitable components and a particularly advantageous compositions with regard to the further processing to surface-active alcohols, if a dimerization catalyst is used which comprises at least one element from Group VIIIb of the Periodic Table and if the catalyst composition and the reaction conditions are so chosen that a mixture of dimers is obtained which comprises less than 10% by weight of compounds exhibiting a structural element of the formula III (vinylidene group)

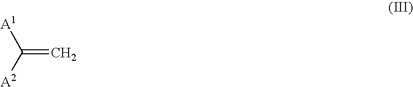

in which A¹ and A² are aliphatic hydrocarbon radicals.

The internal linear pentenes and hexenes present in the metathesis product are preferably used for the dimerization. The use of 3-hexene is particularly preferred.

The dimerization can be carried out under homogeneous catalysis conditions or heterogeneous catalysis conditions. The heterogeneous method is preferred since, in this connection, on the one hand, the catalyst separation is simplified and the process is accordingly more economical and, on the other hand, no environmentally harmful wastewater is produced, as is usually generated in the separation of dissolved catalysts, for example by hydrolysis. A further advantage of the heterogeneous process consists therein, that the dimerization product comprises no halogens, in particular chlorine or fluorine. Homogeneously soluble catalysts generally comprise halide-comprising ligands or they are used in combination with halogen-comprising cocatalysts. Halogen from such catalyst systems can be incorporated in the dimerization products, which has a considerable adverse affect both on the product quality and on the further processing, in particular the hydroformylation to surface-active alcohols.

Combinations of oxides of metals from Group VIIIb with aluminum oxide on supports made of silicon oxides and titanium oxides, such as are known, for example, from DE-A-43 39 713, are advisably used for heterogeneous catalysis. The heterogeneous catalyst can be used in a stationary bed, in which case it is preferably in the coarse-grained form with a particle size of 1 to 1.5 mm, or suspended (particle size 0.05 to 0.5 mm). When carried out under heterogeneous conditions, the dimerization is conveniently carried out at temperatures of 80 to 200° C., preferably of 100 to 180° C., under the pressure prevailing at the reaction temperature, if appropriate also under a positive pressure of protective gas, in a closed system. In order to obtain optimum conversions, the reaction mixture is repeatedly circulated, a certain proportion of the circulating product being continuously ejected and replaced by starting material.

Mixtures of monounsaturated hydrocarbons are obtained in the dimerization, the components of which predominantly have twice the chain length of the starting olefins.

The dimerization catalysts and the reaction conditions are, within the framework of the above statements, advisably chosen in such a way that at least 80% of the components of the dimerization mixture exhibit, in the range from ¼ to ¾, preferably from ⅓ to ⅔, of the chain length of their main chain, a branching or two branchings on neighboring carbon atoms.

Their high proportion, generally over 75%, in particular over 80%, of components with branchings and the low proportion, generally under 25%, in particular under 20%, of unbranched olefins are very characteristic of the olefinic mixtures prepared in this way. A further characteristic is that predominantly groups with (y-4) and (y-5) carbon atoms are bonded to the branching sites of the main chain, y being the number of carbon atoms of the monomer used for the dimerization. The value (y-5)=0 means that no side chain is present.

In the C₁₂ olefin mixtures prepared in this way, the main chain preferably carries methyl or ethyl groups on the branching points.

The position of the methyl and ethyl groups on the main chain is likewise characteristic: in the case of monosubstitution, the methyl or ethyl groups are found in the position P=(n/2)−m of the main chain, n being the length of the main chain and m the carbon number of the side groups; in the case of disubstitution products, one substituent is found in the position P and the other on a neighboring carbon atom P+1. The proportions of monosubstitution products (single branching) in the olefin mixture prepared according to the invention are characteristically on the whole in the range from 40 to 75% by weight and the proportion of double-branched components ranges from 5 to 25% by weight.

It has also been found that the dimerization mixtures are then particularly suitable for further derivatization, if the position of the double bond fulfils certain requirements. In these advantageous olefin mixtures, the position of the double bonds relative to the branchings is characterized in that the ratio of the “aliphatic” hydrogen atoms to “olefinic” hydrogen atoms is in the range H_{aliph.}:H_{olefin.}=(2*n−0.5):0.5 to (2*n−1.9):1.9, n being the number of carbon atoms of the olefin obtained from the dimerization.

(The term “aliphatic” hydrogen atoms is used to describe those which are bonded to carbon atoms which are not part of any C═C double bond (pi bond) and the term “olefinic” hydrogen atoms is used to describe those which are bonded to a carbon atom which brings about a pi bond.)

Particular preference is given to dimerization mixtures in which the ratio

H_{aliph.}:H_{olefin.}=(2*n−1.0):1 to (2*n−1.6):1.6.

The olefin mixtures thus prepared are first hydroformylated to surface-active alcohols (oxo alcohols), branched primary alcohols, by reaction with carbon monoxide and hydrogen in the presence of suitable catalysts, preferably cobalt- or rhodium-comprising catalysts.

A good review of the process for the hydroformylation with numerous additional literature references is found, for example, in the comprehensive article by Beller et al. in Journal of Molecular Catalysis, A104 (1995), 17-85, or in Ullmann's Encyclopedia of Industrial Chemistry, Vol. A5 (1986), page 217 ff., page 333, and the literature references relating thereto.

The extensive information given therein allows a person skilled in the art also to hydroformylate the branched olefins according to the invention. In this reaction, CO and hydrogen are added to olefinic double bonds, mixtures of aldehydes and alkanols being obtained according to the following reaction scheme:

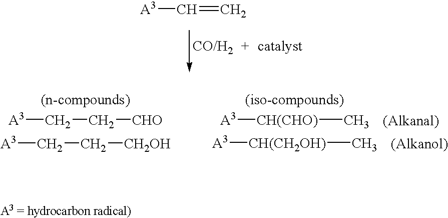

The molar ratio of n-compounds to iso-compounds in the reaction mixture generally ranges, according to the processing conditions chosen for the hydroformylation and the catalyst used, from 1:1 to 20:1. The hydroformylation is normally carried out in the temperature range from 90 to 200° C. and at a CO/H₂ pressure of 2.5 to 35 MPa (25 to 350 bar). The mixing ratio of carbon monoxide to hydrogen depends on whether mainly alkanals or alkanols are meant to be produced. The process is advisably carried out in the CO:H range from 10:1 to 1:10, preferably 3:1 to 1:3, the range of the low hydrogen partial pressures being chosen for the preparation of alkanals and the range of the high hydrogen partial pressures, e.g. CO:H₂=1:2, being chosen for the preparation of alkanols.

Metal compounds of the general formula HM(CO)₄ or M₂(CO)₈ are suitable especially as catalysts, M being a metal atom, preferably a cobalt, rhodium or ruthenium atom.

Generally, under hydroformylation conditions, the catalysts or catalyst precursors used in each case give rise to catalytically active entities of the general formula HₓM_{y}(CO)_{z}L_{q}, in which M represents a metal of Group VIIIb, L represents a ligand, which can be a phosphine, phosphite, amine, pyridine or any other donor compound, also in polymeric form, and q, x, y and z represent integers which depend on the valency and nature of the metal and on the covalence of the ligand L, it also being possible for q to be 0.

The metal M is preferably cobalt, ruthenium, rhodium, palladium, platinum, osmium or iridium and in particular cobalt, rhodium or ruthenium.

Suitable rhodium compounds or complexes are, e.g., rhodium(II) and rhodium(III) salts, such as rhodium(III) chloride, rhodium(III) nitrate, rhodium(III) sulfate, potassium rhodium sulfate, rhodium(II) carboxylate, rhodium(III) carboxylate, rhodium(II) acetate, rhodium(III) acetate, rhodium(III) oxide or salts of rhodium(III) acid, such as, e.g., trisammoniumhexachlororhodate(III). Furthermore, rhodium complexes, such as rhodiumbiscarbonylacetylacetonate or acetylacetonatobisethylenerhodium(I), are suitable. Rhodiumbiscarbonylacetylacetonate or rhodium acetate are preferably used.

Suitable cobalt compounds are, for example, cobalt(II) chloride, cobalt(II) sulfate, cobalt(II) carbonate, cobalt(II) nitrate, their amine or hydrate complexes, cobalt carboxylates, such as cobalt acetate, cobalt ethylhexanoate or cobalt naphthanoate, and the cobalt caprolactamate complex. The carbonyl complexes of cobalt, such as dicobaltoctocarbonyl, tetracobaltdodecacarbonyl and hexacobalthexadecacarbonyl, can also be used here.

The abovementioned cobalt, rhodium and ruthenium compounds are known in principle and are extensively described in the literature or they can be prepared by a person skilled in the art analogously to the compounds already known.

The hydroformylation can be carried out with addition of inert solvents or diluents or without such addition. Suitable inert additives are, for example, acetone, methyl ethyl ketone, cyclohexanone, toluene, xylene, chlorobenzene, methylene chloride, hexane, petroleum ether, acetonitrile and the high boiling components from the hydroformylation of the dimerization products.

If the hydroformylation product obtained exhibits an excessively high aldehyde content, this content can be corrected in a simple way by a hydrogenation, for example with hydrogen in the presence of Raney nickel or using other catalysts known for hydrogenation reactions, in particular catalysts comprising copper, zinc, cobalt, nickel, molybdenum, zirconium or titanium. In the course of this, the aldehyde components are largely hydrogenated to alkanols. A virtually complete removal of aldehyde components in the reaction mixture can, if desired, be achieved by posthydrogenation, for example under particularly mild and economical conditions with an alkali metal borohydride.

The C₁₃ alcohol mixture according to the invention can be extracted pure from the reaction mixture obtained after the hydrogenation using conventional purification processes known to a person skilled in the art, in particular by fractional distillation.

C₁₃ alcohol mixtures according to the invention generally exhibit a mean degree of branching of 1 to 4, preferably of 2.1 to 2.5, in particular 2.2 to 2.4. Degree of branching is defined as the number of the methyl groups in a molecule of the alcohol minus 1. The mean degree of branching is the statistical mean of the degrees of branching of the molecules of a sample. The mean number of the methyl groups in the molecules of a sample can be easily determined by ¹H NMR spectroscopy. For this, the signal area corresponding to the methyl protons in the ¹H NMR spectrum of a sample is divided by three and compared with the signal area of the methylene protons in the CH₂—OH group divided by two.

Within the scope of this embodiment, based on C₁₃ oxo alcohols, those alcohol alkoxylates are particularly preferred which are either ethoxylated or which are block alkoxylates of the EO-PO type.

The degree of ethoxylation of the ethoxylated C₁₃ oxo alcohols to be used according to the invention is generally 1 to 50, preferably 3 to 20 and in particular 3 to 10, especially 4 to 10 and in particular 5 to 10.

The degrees of alkoxylation of the EO-PO block alkoxylates to be used according to the invention depends on the arrangement of the blocks. If the PO blocks are arranged terminally, then the ratio of EO units to PO units is generally at least 1, preferably 1:1 to 4:1 and in particular 1.5:1 to 3:1. At the same time, the degree of ethoxylation is generally 1 to 20, preferably 2 to 15 and in particular 4 to 10 and the degree of propoxylation is generally 1 to 20, preferably 1 to 8 and in particular 2 to 5. The overall degree of alkoxylation, i.e. the sum of EO and PO units, is generally 2 to 40, preferably 3 to 25 and in particular 6 to 15. On the other hand, if the EO blocks are arranged terminally, the ratio of PO blocks to EO blocks is then less critical and is generally 1:10 to 3:1, preferably 1:1.5 to 1:6. At the same time, the degree of ethoxylation is generally 1 to 20, preferably 2 to 15 and in particular 4 to 10 and the degree of propoxylation is generally 0.5 to 10, preferably 0.5 to 6 and in particular 1 to 4. The overall degree of alkoxylation is generally 1.5 to 30, preferably 2.5 to 21 and in particular 5 to 14.

According to a further preferred embodiment, alcohol alkoxylates based on C₁₀ oxo alcohols are used.

The term “C₁₀ oxo alcohol” represents, analogously to the term “C₁₃ oxo alcohol” which has already been explained, C₁₀ alcohol mixtures with the main component formed of at least one branched C₁₀ alcohol (isodecanol).

Suitable C₁₀ alcohol mixtures can generally be obtained by hydrogenation of hydroformylated trimeric propene. It is possible in particular
a) to bring propenes, for the purpose of oligomerization, into contact with a suitable catalyst,
b) to isolate a C₉ olefin fraction from the reaction mixture,
c) to hydroformylate the C₉ olefin fraction by reaction with carbon monoxide and hydrogen in the presence of a suitable catalyst, and
d) to hydrogenate.

Particular embodiments of this procedure arise by analogy to the embodiments described above for the hydrogenation of hydroformylated trimeric butene.

Within the scope of this embodiment, based on C₁₀ oxo alcohols, those alcohol alkoxylates are particularly preferred which are either ethoxylated or which are block alkoxylates of the EO-PeO type.

The degree of ethoxylation of the ethoxylated C₁₀ oxo alcohols to be used according to the invention is generally 1 to 50, preferably 2 to 20 and in particular 2 to 10, especially 3 to 10 and in particular 3 to 10.

The degrees of alkoxylation of the EO-PeO block alkoxylates to be used according to the invention depends on the arrangement of the blocks. If the PeO blocks are arranged terminally, then the ratio of EO units to PeO units is generally at least 1, preferably 2:1 to 25:1 and in particular 4:1 to 15:1. At the same time, the degree of ethoxylation is generally 1 to 50, preferably 4 to 25 and in particular 6 to 15 and the degree of pentyloxation is generally 0.5 to 20, preferably 0.5 to 4 and in particular 0.5 to 2. The overall degree of alkoxylation, i.e. the sum of EO and PeO units, is generally 1.5 to 70, preferably 4.5 to 29 and in particular 6.5 to 17. On the other hand, if the EO blocks are arranged terminally, the ratio of PeO blocks to EO blocks is then less critical and is generally 1:50 to 1:3, preferably 1:25 to 1:5. At the same time, the degree of ethoxylation is generally 3 to 50, preferably 4 to 25 and in particular 5 to 15 and the degree of pentoxylation is generally 0.5 to 20, preferably 0.5 to 4 and in particular 0.5 to 2. The overall degree of alkoxylation is generally 3.5 to 70, preferably 4.5 to 45 and in particular 5.5 to 17.

It follows, from the preceding explanations, that in particular the C₁₃ oxo alcohols or C₁₀ oxo alcohols to be used according to the invention are based on olefins which are already branched. In other words, branchings are not only to be attributed to the hydroformylation reaction, as would be the case in the hydroformylation of straight-chain olefins. Therefore, the degree of branching of alkoxylates to be used according to the invention is generally greater than 1.

The alkoxylates to be used according to the invention generally exhibit a relatively small contact angle. Particular preference is given to alkoxylates with a contact angle of less than 120° and preferably of less than 100°, when this is determined in a way known per se from an aqueous solution comprising 2% by weight of alkoxylate on a paraffin wax surface.

The surface-active properties of the alcohol alkoxylates depend, according to one aspect, on the nature and distribution of the alcohol alkoxylate grouping. The surface tension, which can be determined by the pendant drop method, of alcohol alkoxylates to be used according to the invention preferably ranges from 25 to 70 mN/m and in particular from 28 to 50 mN/m, for a solution comprising 0.1% by weight of alcohol alkoxylate, and from 25 to 70 mN/m and in particular from 28 to 45 mN/m, for a solution comprising 0.5% by weight of alcohol alkoxylate. Alcohol alkoxylates to be used preferably according to the invention hence qualify as amphiphilic substances.

The above alcohol alkoxylates are suitable in particular in the application of the benzamide oxime derivatives of the formula Ia

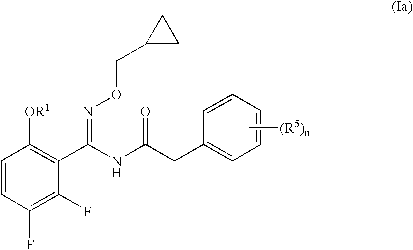

in which
R¹ is defined as above;
R⁵ represents hydrogen, halogen, C₁-C₄-alkyl, C₁-C₄-haloalkyl, C₁-C₄-alkoxy or C₁-C₄-haloalkoxy; and
n is 1, 2 or 3.

From these, benzamide oxime derivatives of the formula (I) or (Ia) are preferred in which R¹ represents difluoromethyl or trifluoromethyl and R⁵ is hydrogen, thus N-phenylacetyl-2-difluoromethoxy-5,6-difluorobenzamide (O-cyclopropylmethyl)oxime and N-phenylacetyl-2-trifluoromethoxy-5,6-difluorobenzamide (O-cyclopropylmethyl)oxime.

The benzamide oxime derivatives can be used together with additional active compounds, e.g. with herbicides, insecticides, growth regulators or fungicides or also with fertilizers.

On mixing with fungicides, an expansion of the fungicidal spectrum of activity is obtained in many cases.

The following list of fungicides with which the benzamide oxime derivatives can be jointly applied is meant to illustrate the combination possibilities but not to limit them:

aliphatic nitrogen fungicides, e.g. butylamine, cymoxanil, dodicin, dodine, guazatine and iminoctadine;

amide fungicides, e.g. carpropamid, chloraniformethan, cyazofamid, cyflufenamid, diclocymet, ethaboxam, fenoxanil, flumetover, furametpyr, prochloraz, quinazamid, silthiofam and triforine; in particular acylamino acid fungicides, e.g. benalaxyl, benalaxyl-M, furalaxyl, metalaxyl, metalaxyl-M and pefurazoate; benzamide fungicides, e.g. benzohydroxamic acid, tioxymid, trichlamide, zarilamid and zoxamide; furamide fungicides, e.g. cyclafuramid and furmecyclox; phenylsulfamide fungicides, e.g. dichlofluanid and tolylfluanid; valinamide fungicides, e.g. benthiavalicarb and iprovalicarb; and anilide fungicides, e.g. benalaxyl, benalaxyl-M, boscalid, carboxin, fenhexamide, metalaxyl, metalaxyl-M, metsulfovax, ofurace, oxadixyl, oxycarboxin, pyracarbolid, thifluzamide and tiadinil; in particular benzanilide fungicides, e.g. benodanil, flutolanil, mebenil, mepronil, salicylanilide and tecloftalam; furanilide fungicides, e.g. fenfuram, furalaxyl, furcarbanil and methfuroxam; and sulfonanilide fungicides, e.g. flusulfamide;

antibiotic fungicides, e.g. aureofungin, blasticidin-S, cycloheximide, griseofulvin, kasugamycin, natamycin, polyoxins, polyoxorim, streptomycin and validamycin; in particular strobilurin fungicides, e.g. azoxystrobin, dimoxystrobin, fluoxastrobin, kresoxim-methyl, metominostrobin, orysastrobin, picoxystrobin, pyraclostrobin and trifloxystrobin;

aromatic fungicides, e.g. biphenyl, chlorodinitronaphthalene, chloroneb, chlorothalonil, cresol, dicloran, hexachlorobenzene, pentachlorophenol, quintozene, sodium pentachlorophenoxide and tecnazene;

benzimidazole fungicides, e.g. benomyl, carbendazim, chlorfenazole, cypendazole, debacarb, fuberidazole, mecarbinzid, rabenzazole and thiabendazole;

benzimidazole precursor fungicides, e.g. furophanate, thiophanate and thiophanate-methyl; benzothiazole fungicides, e.g. bentaluron, chlobenthiazone and TCMTB; bridged diphenyl fungicides, e.g. bithionol, dichlorophen and diphenylamine;

carbamate fungicides, e.g. benthiavalicarb, furophanate, iprovalicarb, propamocarb, thiophanate and thiophanate-methyl; in particular benzimidazolylcarbamate fungicides, e.g. benomyl, carbendazim, cypendazole, debacarb and mecarbinzid; and carbanilate fungicides, e.g. diethofencarb;

conazole fungicides, in particular imidazoles, e.g. climbazole, clotrimazole, imazalil, oxpoconazole, prochloraz and triflumizole; and triazoles, e.g. azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole and uniconazole-P;

Copper fungicides, e.g. Bordeaux mixture, Burgundy mixture, Cheshunt mixture, copper acetate, basic copper carbonate, copper hydroxide, copper naphthenate, copper oleate, copper oxychloride, copper sulfate, basic copper sulfate, zinc chromate, cufraneb, cuprobam, copper oxide, mancopper and oxine copper;

dicarboximide fungicides, e.g. famoxadone and fluoroimide; in particular dichlorophenyl dicarboximide fungicides, e.g. chlozolinate, dichlozoline, iprodione, isovaledione, myclozolin, procymidone and vinclozolin; and phthalimide fungicides, e.g. captafol, captan, ditalimfos, folpet and thiochlorfenphim;

Dinitrophenol fungicides, e.g. binapacryl, dinobuton, dinocap, dinocap-4, dinocap-6, dinocton, dinopenton, dinosulfon, dinoterbon and DNOC; dithiocarbamate fungicides, e.g. azithiram, carbamorph, cufraneb, cuprobam, disulfiram, ferbam, metam, nabam, tecoram, thiram and ziram; in particular cyclic dithiocarbamate fungicides, e.g. dazomet, etem and milneb; and polymeric dithiocarbamate fungicides, e.g. mancopper, mancozeb, maneb, metiram, polycarbamate, propineb and zineb;

imidazole fungicides, e.g. cyazofamid, fenamidone, fenapanil, glyodin, iprodione, isovaledione, pefurazoate and triazoxide; inorganic fungicides, e.g. potassium azide, potassium thiocyanate, sodium azide and sulfur;

mercury fungicides, in particular inorganic mercury fungicides, e.g. mercury chlorides, such as mercury(II) chloride and mercury(I) chloride, or mercury(II) oxide; organomercury fungicides, e.g. (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulfonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal and tolylmercury acetate;

morpholine fungicides, e.g. aldimorph, benzamorf, carbamorph, dimethomorph, dodemorph, fenpropimorph, flumorph and tridemorph;

organophosphorus fungicides, e.g. ampropylfos, ditalimfos, edifenphos, fosetyl, hexylthiofos, iprobenfos, phosdiphen, pyrazophos, tolclofos-methyl and triamiphos;

organotin fungicides, e.g. decafentin, fentin and tributyltin oxide;

oxathiin fungicides, e.g. carboxin and oxycarboxin;

oxazole fungicides, e.g. chlozolinate, dichlozoline, drazoxolon, famoxadone, hymexazol, metazoxolon, myclozolin, oxadixyl and vinclozolin;

polysulfide fungicides, e.g. barium polysulfide, calcium polysulfide, potassium polysulfide and sodium polysulfide;

pyridine fungicides, e.g. boscalid, buthiobate, dipyrithione, fluazinam, pyridinitril, pyrifenox, pyroxychlor and pyroxyfur;

pyrimidine fungicides, e.g. bupirimate, cyprodinil, diflumetorim, dimethirimol, ethirimol, fenarimol, ferimzone, mepanipyrim, nuarimol, pyrimethanil and triarimol; pyrrole fungicides, e.g. fenpiclonil, fludioxonil and fluoroimide;

quinoline fungicides, e.g. ethoxyquin, halacrinate, 8-hydroxyquinoline sulfate, quinacetol and quinoxyfen;

quinone fungicides, e.g. benquinox, chloranil, dichlone and dithianon;

quinoxaline fungicides, e.g. chinomethionat, chlorquinox and thioquinox;

thiazole fungicides, e.g. ethaboxam, etridiazole, metsulfovax, octhilinone, thiabendazole, thiadifluor and thifluzamide;

thiocarbamate fungicides, e.g. methasulfocarb and prothiocarb;

thiophene fungicides, e.g. ethaboxam and silthiofam;

triazine fungicides, e.g. anilazine;

triazole fungicides, e.g. bitertanol, fluotrimazole and triazbutil;

urea fungicides, e.g. bentaluron, pencycuron and quinazamid;

and additional fungicides, e.g. acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, hexachlorobutadiene, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole and zinc naphthenate.

The fungicides with which the benzamide oxime derivatives can jointly be applied include in particular:

sulfur, dithiocarbamates and their derivatives, such as iron(III) dimethyldithiocarbamate, zinc dimethyldithiocarbamate, zinc ethylenebisdithiocarbamate, manganese ethylenebisdithiocarbamate,

manganese zinc ethylenediaminebisdithiocarbamate, tetramethylthiuram disulfide, ammonia complex of zinc (N,N′-ethylenebisdithiocarbamate), ammonia complex of zinc (N,N′-propylenebisdithiocarbamate), zinc (N,N′-propylenebisdithiocarbamate) or N,N′-polypropylenebis(thiocarbamoyl)disulfide;

nitro derivatives, such as dinitro(1-methylheptyl)phenyl crotonate, 2-sec-butyl-4,6-dinitrophenyl 3,3-dimethylacrylate, 2-sec-butyl-4,6-dinitrophenyl isopropyl carbonate or diisopropyl 5-nitroisophthalate;

heterocyclic substances, such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)phosphinyl]-3-phenyl-1,2,4-triazole, 2,3-dicyano-1,4-dithioanthraquinone, 2-thio-1,3-dithiolo[4,5-b]quinoxaline, methyl 1-(butylcarbamoyl)-2-benzimidazolecarbamate, 2-(methoxycarbonylamino)benzimidazole, 2-(2-furyl)benzimidazole, 2-(4-thiazolyl)benzimidazole, N-(1,1,2,2-tetrachloroethylthio)tetrahydrophthalimide, N-(trichloromethylthio)tetrahydrophthalimide or N-(trichloromethylthio)phthalimide, N-dichlorofluoromethylthio-N′,N′-dimethyl-N-phenylsulfamide, 5-ethoxy-3-trichloromethyl-1,2,3-thiadiazole, 2-thiocyanatomethylthiobenzothiazole, 1,4-dichloro-2,5-dimethoxybenzene, 4-(2-chlorophenylhydrazono)-3-methyl-5-isoxazolone, pyridine-2-thione 1-oxide, 8-hydroxyquinoline or its copper salt, 2,3-dihydro-5-carboxanilido-6-methyl-1,4-oxathiin, 2,3-dihydro-5-carboxanilido-6-methyl-1,4-oxathiin 4,4-dioxide, 2-methyl-5,6-dihydro-4H-pyran-3-carboxanilide, 2-methylfuran-3-carboxanilide, 2,5-dimethylfuran-3-carboxanilide, 2,4,5-trimethylfuran-3-carboxanilide, N-cyclohexyl-2,5-dimethylfuran-3-carboxamide, N-cyclohexyl-N-methoxy-2,5-dimethylfuran-3-carboxamide, 2-methylbenzanilide, 2-iodobenzanilide, N-formyl-N-morpholine 2,2,2-trichloroethyl acetal, piperazin-1,4-diylbis-(1-(2,2,2-trichloroethyl)formamide, 1-(3,4-dichloroanilino)-1-formylamino-2,2,2-trichloroethane, 2,6-dimethyl-N-tridecylmorpholine or its salts, 2,6-dimethyl-N-cyclododecylmorpholine or its salts, N-[3-(p-(tert-butyl)phenyl)-2-methylpropyl]-cis-2,6-dimethylmorpholine, N-[3-(p-(tert-butyl)phenyl)-2-methylpropyl]piperidine, 1-[2-(2,4-dichlorophenyl)-4-ethyl-1,3-dioxolan-2-ylethyl]-H-1,2, 4-triazole, 1-[2-(2,4-dichlorophenyl)-4-(n-propyl)-1,3-dioxolan-2-ylethyl]-1H-1,2,4-triazole, N-(n-propyl)-N-(2,4,6-trichlorophenoxyethyl)-N′-imidazolylurea, 1-(4-chlorophenoxy)-3,3-dimethyl-1-(1H-1,2,4-triazol-1-yl)-2-butanone, (2-chlorophenyl)-(4-chlorophenyl)-5-pyrimidinemethanol, 5-butyl-2-dimethylamino-4-hydroxy-6-methylpyrimidine, bis(p-chlorophenyl)-3-pyridinemethanol, 1,2-bis(3-ethoxycarbonyl-2-thioureido)benzene, 1,2-bis(3-methoxycarbonyl-2-thioureido)benzene, [2-(4-chlorophenyl)ethyl]-(1,1-dimethylethyl)-1H-1,2,4-triazol-1-ethanol, 1-[3-(2-chlorophenyl)-1-(4-fluorophenyl)oxiran-2-ylmethyl]-1H-1,2,4-triazole and various fungicides, such as dodecylguanidine acetate, 3-[3-(3,5-dimethyl-2-oxycyclohexyl)-2-hydroxyethyl]glutarimide, hexachlorobenzene, methyl N-(2,6-dimethylphenyl)-N-(2-furoyl)-DL-alaninate, N-(2,6-dimethylphenyl)-N-(2′-methoxyacetyl)-DL-alanine methyl ester, N-(2,6-dimethylphenyl)-N-chloroacetyl-D,L-2-aminobutyrolactone, N-(2,6-dimethylphenyl)-N-(phenylacetyl)-DL-alanine methyl ester, 5-methyl-5-vinyl-3-(3,5-dichlorophenyl)- 2,4-dioxo-1,3-oxazolidine, 3-(3,5-dichlorophenyl)-5-methyl-5-methoxymethyl-1,3-oxazolidine-2,4-dione, 3-(3,5-dichlorophenyl)-1-isopropylcarbamoylhydantoin, N-(3,5-dichlorophenyl)-1,2-dimethylcyclopropane-1,2-dicarboximide, 2-cyano-[N-(ethylaminocarbonyl)-2-methoximino]acetamide, 1-[2-(2,4-dichlorophenyl)pentyl]-1H-1,2,4-triazole, 2,4-difluoro-α-(1H-1,2,4-triazolyl-1-methyl)benzhydryl alcohol, N-(3-chloro-2,6-dinitro-4-trifluoromethylphenyl)-5-trifluoro- methyl-3-chloro-2-aminopyridine or 1-((bis(4-fluorophenyl)methylsilyl)methyl)-1H-1,2,4-triazole,

strobilurins, such as methyl E-methoximino[α-(o-tolyloxy)-o-tolyl]acetate, methyl E-2-{2-[6-(2-cyanophenoxy)pyrimidin-4-yloxy]phenyl}-3-methoxyacrylate or methyl-E-methoximino[α-(2,5-dimethyloxy)-o-tolyl]acetamide, anilinopyrimidines, such as N-(4,6-dimethylpyrimidin-2-yl)aniline, N-[4-methyl-6-(1-propynyl)pyrimidin-2-yl]aniline or N-[4-methyl-6-cyclopropylpyrimidin-2-yl]aniline,

phenylpyrroles, such as 4-(2,2-difluoro-1,3-benzodioxol-4-yl)pyrrole-3-carbonitrile,

cinnamamides, such as 3-(4-chlorophenyl)-3-(3,4-dimethoxyphenyl)acryloylmorpholine.

Preferred combination partners are
a) azoles, which are preferably chosen from: bromuconazole, cyproconazole, difenoconazole, diniconazole, epoxiconazole, fenbuconazole, fluquinconazole, flusilazole, hexaconazole, metconazole, prochloraz, propiconazole, tebuconazole, triflumizole, flutriafol, myclobutanil, penconazole, simeconazole, ipconazole, triticonazole and prothioconazole;
b) benzophenones of the formula IV,

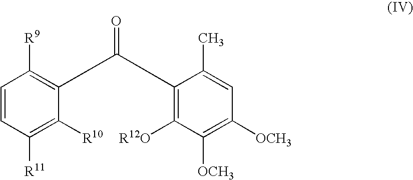

in which
R⁹ represents chlorine, methyl, acetoxy, pivaloyloxy or hydroxyl, preferably methoxy;
R¹⁰ represents chlorine or, preferably, methyl;
R¹¹ represents hydrogen, halogen, preferably bromine, or methyl; and
R¹² represents C₁-C₆-alkyl, preferably methyl, or benzyl, it being possible for the phenyl portion of the benzyl radical to carry a halogen or methyl substituent;
c) oxime ether derivatives of the formula V

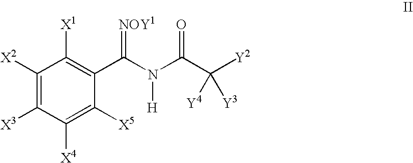

in which the substituents X¹ to X⁵ and Y¹ to Y⁴ have the following meanings:
X¹ is halogen, C₁-C₄-haloalkyl or C₁-C₄-haloalkoxy;
X² to X⁵ are, independently of one another, hydrogen, halogen, C₁-C₄-alkyl, C₁-C₄-haloalkyl, C₁-C₄-alkoxy or C₁-C₄-haloalkoxy;
Y¹ is C₁-C₄-alkyl, C₂-C₆-alkenyl, C₂-C₆-alkynyl or C₁-C₄-alkyl-C₃—C₇-cycloalkyl, it being possible for these radicals to carry one or more substituents chosen from halogen, cyano and C₁-C₄-alkoxy;
Y² is a phenyl radical or a 5- or 6-membered saturated or unsaturated heterocyclic radical with at least one heteroatom chosen from N, O and S, it being possible for the cyclic radicals to have one to three substituents chosen from halogen, C₁-C₄-alkyl, C₁-C₄-alkoxy, C₁-C₄-haloalkyl, C₁-C₄-haloalkoxy, C₁-C₄-alkoxy-C₂-C₄-alkenyl and C₁-C₄-alkoxy-C₂-C₄-alkynyl; and
Y³, Y⁴ are, independently of one another, hydrogen, C₁-C₄-alkyl, C₁-C₄-alkoxy, C₁-C₄-alkylthio, N—C₁-C₄-alkylamino, C₁-C₄-haloalkyl or C₁-C₄-haloalkoxy; and
d) pyraclostrobin.

Emphasis is very particularly laid on combination of benzamide oxime derivatives of the formula (I), and in particular the preferred representatives thereof, with one, two or three of the following active compounds: metrafenone (a benzophenone of the formula (Iv), in which R⁹ represents methoxy, R¹⁰ represents methyl, R¹¹ represents bromine and R¹² represents methyl), epoxiconazole and pyraclostrobin.

The alcohol alkoxylates to be used according to the invention exhibit adjuvant, in particular synergistic, properties. Thus, a higher fungicidal action is observed in comparison when such alcohol alkoxylates are added to the benzamide oxime derivatives of the formula (I) during their application. The adjuvant action results in particular in the following aspects during the application of one or more benzamide oxime derivatives of the formula (I), if appropriate in combination with one or more additional active compounds:
in comparison, higher activity of the benzamide oxime derivatives for a given amount applied;
in comparison, smaller amount of the benzamide oxime derivatives applied for a given action;
in comparison, stronger uptake of the benzamide oxime derivatives by the organism to be treated, in particular a plant, especially via the leaf, and thus advantages in the postemergence procedure, in particular in the spray treatment of plants.

The use according to the invention relates to a number of different application possibilities which are directed in particular toward plant cultivation, agriculture and horticulture. The benzamide oxime derivatives of the formula (I) are useful in particular as fungicides and are thus used for the control of a broad spectrum of phytopathogenic fungi, in particular from the classes of the Ascomycetes, Basidiomycetes, Phycomycetes and Deuteromycetes. Some of them are systemically active and can accordingly also be used as foliar and/or soil fungicides. This is correspondingly valid for combinations of the benzamide oxime derivatives and additional active compounds, in particular fungicides.

The present invention therefore also relates to processes, in accordance with the above intended purposes, for the treatment of organisms which are infected by one or more harmful fungi or for the preventative treatment of organisms for which infection by harmful fungi is feared and therefore would wish to be avoided. The process comprises the application of a suitable amount of active compound and adjuvant.

The organisms to be treated are principally plants or plant parts, such as seeds. The treatment is carried out such that an effective amount, in particular a fungicidally effective amount (amount applied), of the combination of active compound and adjuvant is allowed to act on the harmful fungi, their habitat or the organisms to be kept free therefrom, in particular plants and seeds, soils, areas, materials or spaces.

Advantages are achieved in particular in the control of a multitude of fungi on various cultivated plants, such as cotton, vegetables (e.g. cucumbers, beans, tomatoes, potatoes and cucurbits), barley, grass, oats, bananas, coffee, corn, fruits, rice, rye, soya, vines, wheat, ornamental plants or sugarcane, and on a multitude of seeds. The effective application thereto is within the scope of a person skilled in the art.

Particular advantages are especially in the control of the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and lawns, Ustilago species on cereals and sugarcane, Venturia inaequalis (scab) on apples, Helminthosporium species on cereals, Septoria nodorum on wheat, Botrytis cinera (gray mold) on strawberries, vegetables, ornamental plants and grapevines, Cercospora arachidicola on peanuts, Pseudocercosporella herpotrichoides on wheat and barley, Pyricularia oryzae on rice, Phytophthora infestans on potatoes and tomatoes, Plasmopara viticola on grapevines, Pseudoperonospora species on hops and cucumbers, Alternaria species on fruit and vegetables, Mycosphaerella species on bananas, and Fusarium and Verticillium species.

In principle, the amount of active compound applied can be greatly varied as a result of high plant tolerance. Typically, the amounts applied according to the invention are, for the benzamide oxime derivatives of the formula (I), generally 0.001 to 2.5 kg/ha, preferably 0.005 to 2 kg/ha, in particular 0.01 to 1.0 kg/ha, and, with alcohol alkoxylates, generally 0.001 to 25 kg/ha, preferably 0.05 to 2 kg/ha, in particular 0.1 to 1 kg/ha.

In seed treatment, amounts applied are, for the benzamide oxime derivatives of the formula (I), generally 0.001 to 250 g/kg of seed, preferably 0.01 to 100 g/kg, in particular 0.01 to 50 g/kg, and, for the alcohol alkoxylates, generally 0.001 to 250 g/kg, preferably 0.01 to 100 g/kg, in particular 0.01 to 50 g/kg.

The ratio of the amounts applied of alcohol alkoxylates to benzamide oxime derivatives generally ranges from 0.5:1 to 100:1, preferably 1:1 to 50:1, in particular 1:1 to 20:1. According to a particular aspect, the amounts applied of alcohol alkoxylates are greater than amounts applied of benzamide oxime derivatives.

Within the scope of the use according to the invention, the active compounds are generally first, in accordance with agricultural practice, formulated to give a composition and then applied as composition. The adjuvant can already in the course of this be added to the composition comprising the active compound; however, it can also exist separately therefrom, if appropriate, in accordance with agricultural practice, likewise formulated to give an additional composition, and only when actually employed is applied, simultaneously or appropriately spaced in time, with the composition comprising the active compound so that active compound and adjuvant can act together.

The use according to the invention accordingly also comprises the employment of the alcohol alkoxylates according to the invention as “stand alone” product. In this sense, the combination according to the invention of active compound and adjuvant can also be provided in the form of a kit. Such a kit comprises at least two containers. One container comprises at least one benzamide oxime derivative of the formula (I), if appropriate formulated as composition with suitable auxiliaries. An additional container comprises at least one alcohol alkoxylate.

The present invention also relates to compositions with an active compound component (a), comprising (a1) at least one benzamide oxime derivative of the formula (I), and with an adjuvant component (b), comprising (b1) at least one alkoxylated alcohol, the ratio by weight of the component (b1) to the component (a1) being at least 0.5.

The proportion of the component (a) in respect of the total weight of the composition generally comes to more than 1% by weight, preferably more than 2% by weight and in particular more than 2.5% by weight. On the other hand, the proportion of the component (a) in respect of the total weight of the composition generally comes to less than 75% by weight, preferably less than 60% by weight and in particular less than 50% by weight.

The proportion of the component (a1) in respect of the total weight of the composition generally comes to more than 1% by weight, preferably more than 2% by weight and in particular more than 2.5% by weight. On the other hand, the proportion of the component (a1) in respect of the total weight of the composition generally comes to less than 50% by weight, preferably less than 40% by weight and in particular less than 35% by weight.

According to one embodiment of the present invention, the active compound component (a) essentially comprises (a1), i.e.
(a1) one or more benzamide oxime derivatives of the formula (I).

In addition to the component (a1), the active compound component (a) of the composition according to the invention can exhibit at least one additional plant active compound.

According to a particular embodiment, compositions according to the invention comprise, as additional plant active compound:
(a2) at least one or several of the combination partners described above, in particular one or more active compounds, which are chosen from the azoles, benzophenones of the formula (IV), oxime ether derivatives of the formula (V) and pyraclostrobin described above.

The relative proportions of active compounds in such compositions comprising a combination of active compounds are highly variable. According to one aspect, proportionally larger proportions by weight of active compound component (a2) are used than of active compound component (a1). Typically, this ratio by weight of (a2) to (a1) ranges from 1.1:1 to 20:1, preferably from 1.5:1 to 10:1 and in particular from 2:1 to 5:1.

Proportions of the component (b) in respect of the total weight of the composition of more than 1% by weight, preferably of more than 2% by weight and in particular of more than 2.5% by weight are advantageous. On the other hand, proportions of the component (b) in respect of the total weight of the composition of less than 80% by weight, preferably of less than 60% by weight and in particular of less than 50% by weight are generally advisable.

Proportions of the component (b1) in respect of the total weight of the composition of more than 5% by weight, preferably of more than 8% by weight, in particular of more than 10% by weight, especially of more than 15% by weight and in particular of more than 20% by weight are advantageous. On the other hand, proportions of the component (b1) in respect of the total weight of the composition of less than 50% by weight, preferably of less than 45% by weight and in particular of less than 40% by weight are generally advisable.

According to one embodiment of the present invention, the active compound component (b) essentially comprises (b1), i.e. one or more alcohol alkoxylates.

In order to guarantee a satisfactory adjuvant effect, the ratio by weight of component (b1) to component (a1) is preferably more than 0.5, in particular more than 1 and advantageously more than 2.

The compositions according to the invention can, for example, be formulated, and also applied, in the form of ready-to-spray solutions, powders and suspensions or in the form of highly concentrated aqueous, oily or other suspensions, dispersions, emulsions, oil dispersions, pastes, dusts, materials for broadcasting or granules. The application form depends on the intended use; it should always guarantee a distribution of the mixture according to the invention which is as fine and uniform as possible.

Compositions according to the invention preferably belong to the group of the liquid formulations. These include in particular water-soluble concentrates (SL formulations), suspension concentrates (SC formulations), suspoemulsions (SE formulations) and microemulsions.

According to one embodiment, the present invention relates to compositions with high proportions of active compound (concentrates). In this case, the proportion of the component (a) in respect of the total weight of the composition generally comes to more than 100 g/l, preferably more than 200 g/l and in particular more than 250 g/l. On the other hand, it is advisable for the proportion of the component (a) in respect of the total weight of the composition generally to be less than 700 g/l, preferably less than 650 g/l and in particular less than 600 g/l. Ranges from 200 to 600 g/l are therefore preferred. In this connection, the proportion of benzamide oxime derivative usually comes to up to 300 g/l.

According to a particular embodiment of the present invention, the compositions comprise, as component (c), at least one auxiliary.

The component (c) can serve many different purposes. The choice of suitable auxiliaries is usually made according to requirements by a person skilled in the art.

For example, auxiliaries are chosen from
(c1) surface-active auxiliaries;
(c2)suspension agents, antifoaming agents, retention agents, pH buffers and drift retardants;
(c3)trace elements and minerals which can be used by plants;
(c4)chelating agents;
(c5)solvents or diluents.

The proportion of the component (c) in respect of the total weight of the composition is, if present, generally 10 to 60% by weight, preferably 15 to 50% by weight and in particular 20 to 45% by weight.

The term “surface-active auxiliary” means in this instance interface-active or surface-active agents, such as surfactants, dispersing agents, emulsifying agents or wetting agents.

Anionic, cationic, amphoteric and nonionic surfactants can be used in principle.

The anionic surfactants include, for example, carboxylates, in particular alkali metal, alkaline earth metal and ammonium salts of fatty acids, e.g. potassium stearate, which are usually also described as soaps; acylglutamates; sarcosinates, e.g. sodium lauroylsarcosinate; taurates; methylcelluloses; alkyl phosphates, in particular alkyl monophosphates and alkyl diphosphates; sulfates; sulfonates, in particular alkylsulfonates and alkylarylsulfonates, especially alkali metal, alkaline earth metal and ammonium salts of arylsulfonic acids and alkyl-substituted arylsulfonic acids, alkylbenzenesulfonic acids, such as, for example, lignosulfonic acid and phenolsulfonic acid, naphthalene and dibutylnaphthalenesulfonic acids, or dodecylbenzenesulfonates, alkylnaphthalenesulfonates, alkyl methyl ester sulfonates; condensation products of sulfonated naphthalene and derivatives thereof with formaldehyde, condensation products of naphthalenesulfonic acids, phenol- and/or phenolsulfonic acids with formaldehyde or with formaldehyde and urea, or monoalkyl or dialkyl sulfosuccinates; and protein hydrolyzates and lignin sulfite waste liquors. The abovementioned sulfonic acids are advantageously used in the form of their neutral or, if appropriate, basic salts.

The cationic surfactants include, for example, quaternary ammonium salts, in particular alkyltrimethylammonium halides, dialkyldimethylammonium halides, alkyltrimethylammonium alkyl sulfates and dialkyldimethylammonium alkyl sulfates, and pyridine and imidazoline derivatives, in particular alkylpyridinium halides.

The nonionic surfactants include in particular:
alkylaryl alkoxylates, in particular alkylphenol alkoxylates and especially their ethoxylates, such as, for example, ethoxylated isooctylphenol, octylphenol or nonylphenol, tributylphenol polyoxyethylene ether;
fatty alcohol polyoxyethylene alkyl esters, for example lauryl alcohol polyoxyethylene ether acetate;
alkoxylated animal and/or vegetable fats and/or oils, for example corn oil ethoxylates, castor oil ethoxylates or tallow fat ethoxylates;
glycerol esters, such as, for example, glyceryl monostearate,
fatty amine alkoxylates, fatty acid amide alkoxylates and fatty acid diethanolamide alkoxylates, in particular their ethoxylates;
sugar surfactants, in particular sorbitol esters, such as, for example, sorbitan fatty acid esters (sorbitan monooleate, sorbitan tristearate), and ethoxylated carboxylic acids and esters of mono- or polyfunctional alcohols, such as polyoxyethylene sorbitan fatty acid esters, alkyl(poly)glycosides and N-alkylgluconamides;
alkyl methyl sulfoxides;
alkyldimethylphosphine oxides, such as, for example, tetradecyldimethylphosphine oxide;
di-, tri- and multiblock polymers of the (AB)ₓ, ABA and BAB type, e.g. polystyrene-block-polyethylene oxide, and AB comb polymers, e.g. polymethacrylate-comb-polyethylene oxide, and in particular ethylene oxide-propylene oxide block copolymers or their end-capped derivatives.

The amphoteric surfactants include, for example, sulfobetaines, carboxybetaines and alkyldimethylamine oxides, e.g. tetradecyldimethylamine oxide.

Additional surfactants which may be mentioned here by way of example are perfluorinated surfactants, silicone surfactants, phospholipids, such as, for example, lecithin or chemically modified lecithins, amino acid surfactants, e.g. N-lauroylglutamate, and surface-active homo- and copolymers, e.g. polyvinylpyrrolidone, polyacrylic acids in the form of their salts, polyvinyl alcohol, polypropylene oxide, polyethylene oxide, maleic anhydride-isobutene copolymers and vinylpyrrolidone-vinyl acetate copolymers.

The proportion of the component (c1) in respect of the total weight of the composition is, if present, generally up to 20% by weight, preferably up to 15% by weight, especially up to 10% by weight and in particular up to 5% by weight.

Suspension agents can be used in particular for suspension concentrates. These are used especially for rheological stabilization. Mention may in particular be made, in this connection, of inorganic products, e.g. bentonites, talcites and hectorites.

The antifoaming agents include in particular those of silicone type, for example the Silicone SL sold by Wacker, and the like.

The trace elements and minerals which can be used by plants include in particular inorganic ammonium salts, such as ammonium sulfate, ammonium nitrate, ammonium chloride or ammonium phosphate, or other trace elements or minerals which can be used by plants, in particular ammonium nitrate fertilizer granules and/or urea. These can be introduced into the compositions according to the invention, for example, as aqueous concentrates and, if appropriate, mixed concentrates, such as, e.g., Ensol solutions.

If present, the proportion of the component (c3) in respect of the total weight of the composition is generally 0.1 to 35% by weight and preferably 0.2 to 20% by weight.

Preferred chelating agents are compounds which complex heavy metals and in particular transition metals, e.g. EDTA and its derivatives.

If present, the proportion of the component (c4) in respect of the total weight of the composition is generally 0.001 to 0.5% by weight, preferably 0.005 to 0.2% by weight and in particular 0.01 to 0.1% by weight.

The compositions can comprise solvents of soluble constituents or diluents of insoluble constituents of the composition.

Mineral oils, synthetic oils and vegetable and animal oils, and low-molecular-weight hydrophilic solvents, such as alcohols, ethers, ketones, and the like, for example, can be used in principle.

Mention may therefore first be made especially of aprotic or nonpolar solvents or diluents, such as mineral oil fractions of medium to high boiling point, e.g. kerosene and diesel oil, furthermore coal tar oils, hydrocarbons, paraffin oils, e.g. C₈ to C₃₀ hydrocarbons of the n-alkane or isoalkane series or mixtures thereof, or optionally hydrogenated or partially hydrogenated aromatics or alkylaromatics from the benzene or naphthalene series, e.g. aromatic or cycloaliphatic C₇ to C₁₈ hydrocarbon compounds, aliphatic or aromatic carboxylates or dicarboxylates, or fats or oils of vegetable or animal origin, such as mono-, di- or triglycerides, in the pure form or as a mixture, for example in the form of oily extracts of natural substances, e.g. olive oil, soybean oil, sunflower oil, castor oil, sesame oil, corn oil, groundnut oil, rapeseed oil, linseed oil, almond oil, castor oil or safflower oil, and their raffinates, e.g. hydrogenated or partially hydrogenated products thereof, and/or their esters, in particular methyl and ethyl esters.

Examples of C₈ to C₃₀ hydrocarbons of the n-alkane or isoalkane series are n-octane, n-decane, n-hexadecane, n-octadecane, n-icosane, isooctane, isodecane, isohexadecane, isooctadecane and isoicosane, and preferably hydrocarbon mixtures, such as paraffin oil (which as technical grade can comprise up to approximately 5% of aromatics) and a C₁₈-C₂₄ mixture which is commercially available from Texaco under the name Spraytex oil.

The aromatic or cycloaliphatic C₇ to C₁₈ hydrocarbon compounds include in particular aromatic or cycloaliphatic solvents from the alkylaromatics series. These compounds may be nonhydrogenated, partially hydrogenated or completely hydrogenated. Such solvents include in particular mono-, di- or trialkylbenzenes, tetralins substituted by one, two or three alkyl groups and/or naphthalenes substituted by one, two, three or four alkyl groups (alkyl preferably represents C₁-C₆-alkyl). Examples of such solvents are toluene, o-, m- or p-xylene, ethylbenzene, isopropylbenzene, tert-butylbenzene and mixtures, such as the products sold by Exxon under the Shellsol and Solvesso names, e.g. Solvesso 100, 150 and 200.

Examples of suitable monocarboxylates are oleates, in particular methyl oleate and ethyl oleate, laurates, in particular 2-ethylhexyl laurate, octyl laurate and isopropyl laurate, isopropyl myristate, palmitates, in particular 2-ethylhexyl palmitate and isopropyl palmitate, stearates, in particular n-butyl stearate, and 2-ethylhexyl 2-ethylhexanoate.

Examples of suitable dicarboxylates are adipates, in particular dimethyl adipate, di(n-butyl) adipate, di(n-octyl) adipate, di(isooctyl) adipate, also described as bis(2-ethylhexyl) adipate, di(n-nonyl) adipate, di(isononyl) adipate and ditridecyl adipate; succinates, in particular di(n-octyl) succinate and di(isooctyl) succinate, and di(isononyl) cyclohexane-1,2-dicarboxylate.

The proportion of the aprotic solvents or diluents described above in respect of the total weight of the composition is generally less than 30% by weight, preferably less than 20% by weight and in particular less than 5% by weight.

Mention may secondly be made of protic or polar solvents or diluents, e.g. water, C₂-C₈ monoalcohols, such as ethanol, propanol, isopropanol, butanol, isobutanol, tert-butanol, cyclohexanol and 2-ethylhexanol, C₃-C₈ ketones, such as diethyl ketone, t-butyl methyl ketone and cyclohexanone, and aprotic amines, such as N-methylpyrrolidone and N-octylpyrrolidone.

The proportion of the protic or polar solvents or diluents described above in respect of the total weight of the composition is kept low according to the invention and is generally less than 20% by weight, preferably less than 15% by weight and in particular less than 10% by weight.

According to a particular embodiment, the present invention relates to compositions comprising
(a) 2 to 35% by weight of at least one benzamide oxime derivative of the formula (I), preferably N-phenylacetyl-2-difluoromethoxy-5,6-difluorobenzamide (O-cyclopropylmethyl)oxime or N-phenylacetyl-2-trifluoromethoxy-5,6-difluorobenzamide (O-cyclopropylmethyl)oxime, and, if appropriate, 5 to 25% by weight of metrafenone, epoxiconazole or pyraclostrobin, or a mixture of 2 or 3 of these active compounds; and
(b) 5 to 40% by weight of at least one alcohol alkoxylate, preferably an alkoxylated C10 or C13 oxo alcohol; and advantageously
(c) 15 to 45% by weight of one or more auxiliaries.

Compositions according to the invention can be prepared in a way known per se. For this, at least portions of the components are mixed together. In this connection, it may be observed that products, in particular commercial products, can be used which possess constituents which may contribute to different components. For example, a certain surfactant can be dissolved in an aprotic solvent, so that this product can contribute to the components (c1) and (c5) according to the invention. The combined products, as a mixture, can then generally be intensively mixed with one another and, if required, e.g. in the case of suspensions, can be milled.

Mixing can be carried out in a way known per se, e.g. by homogenization using suitable apparatuses, such as KPG or magnetic stirrers.

The present invention also relates to the use of compositions according to the invention in the application possibilities described above.

The compositions can be applied in a way known per se, e.g. by spraying, atomizing, dusting, broadcasting or watering. For this, it may be necessary, first, to prepare a spray mixture, which is then applied, e.g. with a mobile sprayer using nozzles which distribute as finely as possible. The usual devices and working techniques for this are known to a person skilled in the art.

Sprayable mixtures normally comprise 0.0001 to 10, preferably 0.001 to 5 and in particular 0.002 to 2.0% by weight of active compound component (a). For the preparation of a conventional spray mixture, for example 0.2 to 5.0, preferably 0.3 to 3.0 and in particular 0.35 to 2.0 l of an active compound concentrate according to the invention comprising component (a) can be diluted with water to 10 to 2000 l, preferably 50 to 1500 l and in particular 100 to 1000 l. If appropriate, 0.1% by weight to 5% by weight (based on the spray mixture) of additional auxiliaries can be added to the spray mixture. Mention may be made, as examples of materials for such auxiliaries, of starch and starch derivatives, e.g. a starch comprising carboxyl and sulfo groups (Nu Film from Union Carbide Corp.), and spreaders and extenders, such as Vapor Guard from Miller Chemical & Fertilizer Corp.

Within the scope of the present description, amounts generally refer in respect of the total weight of the composition, unless otherwise specified. In accordance with the invention, the expression “essentially” generally describes a percentage ratio of at least 90%, preferably of at least 95% and in particular of at least 98%.

Within the scope of the present description, terms such as alkyl, alkoxy and the like comprise straight-chain or branched hydrocarbon groups, preferably, unless otherwise specified, with 1 to 30 carbon atoms, the fatty radicals generally exhibiting 5 to 30, preferably 8 to 20 and in particular 9 to 16 carbon atoms and the shorter radicals, e.g. as substituents of aromatic groups, generally exhibiting 1 to 10, in particular 1 to 6 and particularly preferably 1 to 4 carbon atoms.

The terms “alkenyl”, and “alkynyl” represent straight-chain or branched mono-, di-, tri-, tetra-, penta- or hexaunsaturated hydrocarbon groups, preferably, unless otherwise specified, with 2 to 30 carbon atoms, the fatty radicals generally exhibiting 5 to 30, preferably 8 to 20 and in particular 9 to 16 carbon atoms and the shorter radicals, e.g. as substituents of aromatic groups, generally exhibiting 2 to 10, in particular 2 to 6 and particularly preferably 1 to 4 carbon atoms. Mention may in particular be made, in this context, of the radicals of mono- or polyunsaturated fatty acids.

The term “halogen” preferably represents fluorine, chlorine, bromine and iodine, in particular fluorine and especially chlorine.

For example:
C₁-C₄-alkyl represents: methyl, ethyl, n-propyl, 1-methylethyl, n-butyl, 1-methylpropyl, 2-methylpropyl or 1,1-dimethylethyl, in particular methyl or ethyl;
C₅-C₄₀-alkyl represents: lauryl, stearyl or cetyl;
C₁-C₄-haloalkyl represents: a C₁-C₄-alkyl radical as mentioned above which is partially or completely substituted by fluorine, chlorine, bromine and/or iodine, e.g. trichloromethyl, trifluoromethyl, 2-fluoroethyl, 2-chloroethyl, 2-bromoethyl, 2,2-difluoroethyl, 2,2,2-trifluoroethyl, 2,2,2-trichloroethyl, 2-fluoropropyl, 3-fluoropropyl, 2-chloropropyl or 3-chloropropyl, in particular 2-fluoroethyl or 2-chloroethyl;
cyano-C₁-C₄-alkyl represents: e.g., cyanomethyl, 1-cyanoeth-1-yl, 2-cyanoeth-1-yl, 1-cyanoprop-1-yl, 2-cyanoprop-1-yl, 3-cyanoprop-1-yl, 1-cyanoprop-2-yl or 2-cyanoprop-2-yl, in particular cyanomethyl or 2-cyanoethyl;
C₁-C₄-alkoxy represents: methoxy, ethoxy, n-propoxy, 1-methylethoxy, n-butoxy, 1-methylpropoxy, 2-methylpropoxy or 1,1-dimethylethoxy, in particular methoxy or ethoxy;
C₁-C₄-alkoxy-C₁-C₄-alkyl represents: C₁-C₄-alkyl substituted by C₁-C₄-alkoxy as mentioned above, thus, e.g., methoxymethyl, ethoxymethyl, n-propoxymethyl, (1-methylethoxy)methyl, n-butoxymethyl, (1-methylpropoxy)methyl, (2-methylpropoxy)methyl, (1,1-dimethylethoxy)methyl, 2-(methoxy)ethyl or 2-(ethoxy)ethyl, in particular methoxymethyl or 2-methoxyethyl;
C₂-C₆-alkenyl represents: e.g., ethenyl, prop-2-en-1-yl, n-buten-4-yl, 1-methylprop-2-en-1-yl, 2-methylprop-2-en-1-yl or 2-buten-1-yl, in particular prop-2-en-1-yl;
C₃-C₆-haloalkenyl represents: C₃-C₆-alkenyl as mentioned above which is partially or completely substituted by fluorine, chlorine and/or bromine, e.g. 2-chloroallyl, 3-chloroallyl, 2,3-dichloroallyl or 3,3-dichloroallyl, in particular 2-chloroallyl;
C₂-C₆-alkynyl represents: e.g., ethynyl, prop-1-yn-1-yl, prop-2-yn-1-yl, n-but-1-yn-1-yl, n-but-1-yn-3-yl, n-but-1-yn-4-yl or n-but-2-yn-1-yl, in particular prop-2-yn-1-yl;
C₃-C₈-cycloalkyl-C₁-C₄-alkyl represents: e.g., cyclopropylmethyl, cyclobutylmethyl, cyclopentylmethyl, cyclohexylmethyl, (cyclopropyl)ethyl, 1-(cyclobutyl)ethyl, 1-(cyclopentyl)ethyl, 1-(cyclohexyl)ethyl, 1-(cycloheptyl)ethyl, 1-(cyclooctyl)ethyl, 2-(cyclopropyl)ethyl or 2-(cyclobutyl)ethyl, in particular cyclopentylmethyl;
phenyl-C₁-C₆-alkyl represents: e.g., benzyl, 1-phenylethyl, 2-phenylethyl, 1-phenylprop-1-yl, 2-phenylprop-1-yl or 3-phenylprop-1-yl, in particular benzyl or 2-phenylethyl;
thienyl-C₁-C₄-alkyl represents: e.g., 2-thienylmethyl, 3-thienylmethyl or 2-thienylethyl;
pyrazolyl-C₁-C₄-alkyl represents: e.g., 1-pyrazolylmethyl, 2-pyrazolylmethyl, 3-pyrazolylmethyl or 2-pyrazolylethyl.

The invention is more fully illustrated by the following example:

### EXAMPLE 1

### Biological Activity (Curative Control of Powdery Mildew of Wheat)

Leaves of wheat seedlings of the variety “Kanzler” grown in pots were dusted at the two-leaf stage with spores of powdery mildew of wheat (Erysiphe [syn. Blumeria] graminis forma specialis tritici) and were grown in a greenhouse until the preinfection averaged 20%. The plants were then sprayed with an aqueous suspension or emulsion which comprised the active compound and adjuvants given below. The suspension or emulsion was prepared from a stock solution with 10% active compound in a mixture consisting of 85% cyclohexanone and 5% emulsifier. After the spray coating had dried on, the plants were again returned to the greenhouse. The test plants were placed in the greenhouse at temperatures between 20 and 24° C. and a relative atmospheric humidity of 60 to 90%. 20 or 30 days after application, the extent of the development of powdery mildew was determined visually in % infection of the total leaf area.

TABLE 1
% infection of the leaves after application of the
aqueous active compound formulation, which corresponded to an
amount applied of 7.5 g of active substance per ha

| | | | | % Infection | % Infection |
|---|---|---|---|---|---|
| | | | | (Day | (Day |
| Active compound | [g/ha] | Adjuvant | [g/ha] | 20) | 20) |
| Active compound A | 7.5 | | | 20 | 56 |
| | | Alkoxylate 1 | 200 | 47 | 81 |
| | | Alkoxylate 2 | 200 | 49 | 79 |
| Active compound A | 7.5 | Alkoxylate 1 | 200 | 6 | 4 |
| Active compound A | 7.5 | Alkoxylate 2 | 200 | 10 | 11 |
| Active compound A + Metrafenone | 7.5 + 22.5 | | | 11 | 12 |
| Active compound A + Metrafenone | 7.5 + 22.5 | Alkoxylate 1 | 200 | 2 | 2 |
| Active compound A + Metrafenone | 7.5 + 22.5 | Alkoxylate 2 | 200 | 8 | 6 |
| Active compound A + Metrafenone + Epoxiconazole | 7.5 + 22.5 + 18.75 | | | 8 | 9 |
| Active compound A + Metrafenone + Epoxiconazole | 7.5 + 22.5 + 18.75 | Alkoxylate 1 | 200 | 2 | 2 |
| Active compound A + Metrafenone + Epoxiconazole | 7.5 + 22.5 + 18.75 | Alkoxylate 2 | 200 | 4 | 2 |
| Active compound A + Metrafenone + Epoxiconazole + Pyraclostrobin | 7.5 + 22.5 + 18.75 + 22.5 | | | 5 | 4 |
| Active compound A + Metrafenone + Epoxiconazole + Pyraclostrobin | 7.5 + 22.5 + 18.75 + 22.5 | Alkoxylate 1 | 200 | 2 | 2 |
| Active compound A + Metrafenone + Epoxiconazole + Pyraclostrobin | 7.5 + 22.5 + 18.75 + 22.5 | Alkoxylate 2 | 200 | 4 | 3 |
| Untreated | | | | 51 | 86 |

Active compound A: N-Phenylacetyl-2-difluoromethoxy-5,6-difluoro-benzamide (O-cyclopropylmethyl)oxime
Alkoxylate 1: C10 oxo alcohol × 3 EO
Alkoxylate 2: C13 oxo alcohol × 6 EO × 3 PO

It is clearly apparent that the alcohol alkoxylates used increase the fungicidal action of the active compounds or active compound mixtures.

1. A composition comprising
(a1) at least one benzamide oxime derivative of the formula (I) 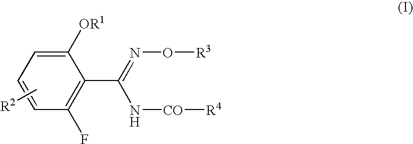
in which the substituents have the following meanings:
R¹ is difluoromethyl or trifluoromethyl;
R² is hydrogen or fluorine;
R³ is C₁-C₄-alkyl, which can be substituted by cyano, C₁-C₄-haloalkyl, C₁-C₄-alkoxy-C₁-C₄-alkyl, C₃-C₆-alkenyl, C₃-C₆-haloalkenyl, C₃-C₆-alkynyl or C₃-C₈-cycloalkyl-C₁-C₄-alkyl;
R⁴ is phenyl-C₁-C₆-alkyl, which can carry, on the phenyl ring, one or more subsituents chosen from halogen, C₁-C₄-alkyl, C₁-C₄-haloalkyl, C₁-C₄-alkoxy and C₁-C₄-haloalkoxy, or thienyl-C₁-C₄-alkyl, which can carry, on the thienyt ring, one or more substituents chosen from halogen, C₁-C₄-alkyl, C₁-C₄-haloalkyl, C₁-C₄-alkoxy and C₁-C₄-haloalkoxy, or pyrazolyl-C₁-C₄-alkyl, which can carry, on the pyrazolyl ring, one or more substituents chosen from halogen, C₁-C₄-alkyl, C₁-C₄-haloalkyl, C₁-C₄-alkoxy or C₁-C₄-haloalkoxy,
(b1) at least one alkoxylated alcohol,
in which the ratio by weight of the component (b1) to (a1) is at least 0.5.

2. The composition according to claim 1, wherein the proportion of the component (b1) in respect of the total weight of the composition is greater than the proportion of the component (a1).

3. The composition according to claim 1, wherein the alcohol exhibits 5 to 30, preferably 8 to 20 and in particular 9 to 15 carbon atoms.

4. The composition according to claim 1, wherein the degree of alkoxylation is 1 to 100, preferably 1 to 25, in particular 2 to 15 and particularly preferably 3 to 12.

5. The composition according to claim 1, wherein the alkoxylated alcohol is chosen from alcohol alkoxylates of the formula (II)
R⁶—O—)CₘH₂ₘO)ₓ—(CₙH₂ₙO)_{y}—(CₚH₂ₚO)_{z}—H (II)
in which
R⁶ represents C₅-C₃₀-alkyl or C₅-C₃₀-alkenyl;
m,n,p represent, independently of one another, an integer from 2 to 16, preferably 2, 3, 4 or 5;
x,y,z represent, independently of one another, a number from 0 to 100; and
x+y+z corresponds to a value from 1 to 100.

6. The composition according to claim 5, wherein m=2, the value of x is greater than zero and z=0.

7. The composition according to claim 6, wherein y is zero.

8. The composition according to claim 6, wherein y is greater than zero.

9. The composition according to claim 8, wherein n=3.

10. The composition according to claim 9, wherein the ratio of x to y is 1:1 to 4:1 and in particular 1.5:1 to 3:1.

11. The composition according to claim 8, wherein n=5.

12. The composition according to claim 11, wherein the value of x is 1 to 50 and preferably 4 to 25 and the value of y is 0.5 to 20, preferably 0.5 to 4 and in particular 0.5 to 2.

13. The composition according to claim 5, wherein n=2, the values of y and x are in each case greater than zero and z=0.

14. The composition according to claim 13, wherein m=3.

15. The composition according to claim 14, wherein the ratio of x to y is 1:10 to 3:1 and in particular 1.5:1 to 1:6.

16. The composition according to claim 13, wherein m=5.

17. The composition according to claim 16, wherein the value of x is 0.5 to 20, preferably 0.5 to 4 and in particular 0.5 to 2 and the value of y is 3 to 50 and preferably 4 to 25.

18. The composition according to claim 5, wherein the alcohol is 2-propylheptanol.

19. The composition according to claim 5, wherein the alcohol is a C13 oxo alcohol.

20. The composition according to claim 19, wherein the C13 oxo alcohol is obtained by hydrogenation of hydroformylated trimeric butene.

21. The composition according to claim 19, wherein the C13 oxo alcohol is obtained by hydrogenation of hydroformylated dimeric hexene.

22. The composition according to claim 5, wherein the alcohol is a C10 oxo alcohol.

23. The composition according to claim 22, wherein the C10 oxo alcohol is obtained by hydrogenation of hydroformylated trimeric propene.

24. The composition according to claim 1, wherein the benzamide oxime derivative is a compound of the formula Ia 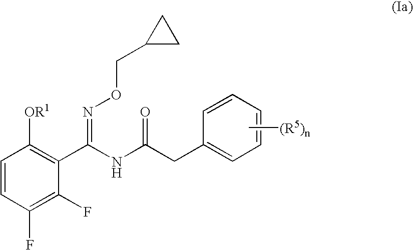
in which
R¹ is as defined above;
R⁵ represents hydrogen, halogen, C₁-C₄-alkyl, C₁-C₄-haloalkyl, C₁-C₄-alkoxy or C₁—C₄-haloalkoxy; and
n is 1, 2 or 3.

25. The composition according to claim 24, wherein the benzamide oxime derivative is N-phenylacetyl-2-difluoromethoxy-5,6-difluorobenzamide (O-cyclopropylmethyl)oxime or N-phenylacetyl-2-trifluoromethoxy-5,6-difluorobenzamide (O-cyclopropylmethyl)oxime.

26. The composition according to claim 1, comprising
(a2) at least one additional fungicide.

27. The composition according to claim 26, wherein the additional fungicide is chosen from metrafenone, epoxiconazole and pyraclostrobin.

28. The composition according to claim 1, comprising
(c) additional auxiliaries.

29. The composition according to claim 1, comprising
(a) 2 to 35% by weight of at least one benzamide oxime derivative of the formula (I), preferably N-phenylacetyl-2-difluoromethoxy-5,6-difluorobenzamide (O-cyclopropylmethyl)oxime or N-phenylacetyl-2-trifluoromethoxy-5,6-difluorobenzamide (O-cyclopropylmethyl)oxime, and if appropriate 5 to 25% by weight of metrafenone, epoxiconazole or pyraclostrobin, or a mixture of 2 or 3 of these active compounds; and
(b) 5 to 40% by weight of at least one alcohol alkoxylate, preferably an alkoxylated C10 or C13 oxo alcohol; and advantageously
(c) 15 to 45% by weight of one or more auxiliaries.

30. A kit with at least two containers, in which
(a1) a first container comprises at least one benzamide oxime derivative of the formula (I) and the benzamide oxime derivative is defined as in any of the preceding claims; and
(b1) a second container comprises at least one alkoxylated alcohol and the alkoxylated alcohol is defined as in claim 1.

31. The use of an alkoxylated alcohol for improving the fungicidal action of a benzamide oxime derivative of the formula (I), in which the benzamide oxime derivative of the formula (I) is defined as claim 1.

32. The use according to claim 31, wherein the ratio of the amounts applied of alcohol alkoxylate to benzamide oxime derivative ranges from 0.5:1 to 100: 1, preferably from 1:1 to 50:1, in particular from 1:1 to 20:1.

33. The use according to claim 31, wherein the amount of alcohol alkoxylate applied is greater than the amount of benzamide oxime derivative applied.
